(19) United States
(12) Patent Application Publication
(10) Pub. No.: US 2005/0125334 A1
(43) Pub. Date: Jun. 9, 2005

(54) Automated method and system for processing mortgage leads

(76) Inventors: Eric Masella, New York, NY (US); Jordan Richter, Villanova, PA (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/928,471

(22) Filed: Aug. 27, 2004

Related U.S. Application Data
(60) Provisional application No. 60/526,467, filed on Dec. 3, 2003.

(51) Int. Cl. G06F 17/60

(52) U.S. Cl. 705/38

(57) ABSTRACT

An automated, computerized method for processing mortgage leads is disclosed. The method according to an exemplary embodiment of the present invention includes the steps of aggregating and storing mortgage leads from a plurality of mortgage lead suppliers, and storing mortgage lead order criteria information and mortgage lead source selection information for each of a plurality of mortgage lead buyers. Further to the method, the mortgage lead order criteria information and mortgage lead source selection information are used to allocate and distribute the stored mortgage leads to the plurality of mortgage lead buyers.

This claims the benefit of U.S. Provisional Patent Application No. 60/526,467, filed Dec. 3, 2003.

### BACKGROUND OF THE INVENTION

Mortgage financing provides the foundation for home ownership. For example, a purchase money mortgage enables an individual to purchase a home. The individual will take out a loan from a financial institution, and use the proceeds of the loan to purchase the home. As an inducement to the financial institution to make the loan, the loan is secured by a mortgage granted by the individual to the financial institution. The mortgage serves to provide the equity in the purchased home as collateral to secure the loan. In this manner, the individual is able to acquire the home, and the financial institution is able to make a high quality investment via a secured loan.

Mortgage financing has become a multi-trillion dollar industry. Mortgages comprise a significant asset class for many large financial institutions, including banks, insurance companies, savings and loan associations, and so on. In view of the importance of mortgages, considerable marketing efforts have been undertaken by financial institutions to generate mortgage business. These efforts include advertising campaigns and the development of large referral networks of financial advisors, real estate agents, attorneys, and other individuals in the real estate industry, who refer clients and customers who are in need of a mortgage, to the financial institution. Financial institutions also maintain relationships with mortgage brokers, who act as middlemen between individuals in need of mortgage financing, and the financial institutions.

A mortgage lead industry has also developed as a mechanism to supply mortgage brokers and financial institutions acting as mortgage lenders, with lead information regarding qualified, in-market, prospective mortgage borrowers. An in-market lead may be defined as data submitted by a prospective borrower who has indicated a desire to be contacted by a mortgage broker or lender, as soon as possible, for mortgage quote information. Many of the individuals involved in the development of the mortgage lead market have expertise in direct marketing. Most financial institutions do not have adequate in-house expertise in direct marketing, and so rely upon outside direct marketing firms to engage in the activities required to generate mortgage leads. These direct marketing firms rely upon various techniques and technologies to obtain information on in-market, prospective borrowers. These include the use of telemarketing, e mail, internet web sites and search listings. Qualified mortgage leads for in-market, prospective borrowers are of significant value to mortgage brokers and lenders, and recently, have been sold for as much as from $5 to up to $50 or more per lead. In addition, some leads are sold with an obligation to pay a commission on any loan funds disbursed as a result of a follow up on the lead.

Currently, the great value of mortgage leads has caused significant growth in the number of firms engaging in direct marketing activities designed to generate mortgage leads. At present, there are dozens of direct marketing firms acting as mortgage lead suppliers or sellers to mortgage lead buyers such as mortgage brokers and lenders. In order to assure a steady supply of quality leads, each mortgage lead buyer must maintain relationships with a considerable number of different mortgage lead suppliers. This results in high administrative costs for the mortgage lead buyers. This is particularly true when each lead supplier relationship is structured with differing terms and conditions, modes of lead delivery, billing and format for organizing lead data. It also makes it difficult for the buyers to monitor the quality of leads, and to filter out unusable leads such as duplicate leads, leads for existing borrowers, and leads with false or fictitious information.

Moreover, the mortgage lead suppliers typically employ manual and/or inefficient methods of processing and distributing mortgage leads. A mortgage lead supplier must collect lead information from various lead generation points such as lead generating web sites, and then manually parse through the collected leads to classify the leads by such characteristics as, for example, state, loan type, credit rating, etc. On this basis, lead suppliers have at best, been able to generate leads for lead buyers who are licensed in 20 or more different states, or on a national level. Selling leads to buyers who do business in less that 20 states often results in administrative overheads that are cost prohibitive.

Overall, the large number of different mortgage lead suppliers, and multiple, individual relationships between lead suppliers and buyers results in a fragmented and inefficient mortgage lead marketplace. This is of particular concern in that mortgage leads are in essence perishable commodities. Each in-market prospective borrower is typically about to buy a home, or wants to refinance an existing home, and is therefore, expecting a response as soon as possible. In the event a response to a lead is not forthcoming after a very short period of time, for example, within 24 hours, the lead losses value, since the prospective borrower may have already contacted another lending institution. Consequently, there is a current condition of the mortgage lead market being an under served customer segment that represents a large percentage of mortgage loan origination.

### SUMMARY OF THE INVENTION

The present invention provides an automated system and method for processing mortgage leads to facilitate a liquid market for an efficient distribution of mortgage leads from lead suppliers to lead buyers.

In a first embodiment of the present invention, an automated, computerized method for processing mortgage leads is provided. The method according to the present invention includes the steps of aggregating mortgage leads from a plurality of mortgage lead suppliers, and storing mortgage lead order criteria information and mortgage lead source selection information for each of a plurality of mortgage lead buyers. Further to the method, the mortgage lead order criteria information and mortgage lead source selection information are used to allocate and distribute the mortgage leads to the plurality of mortgage lead buyers.

In a second embodiment of the present invention, a further automated, computerized method for processing mortgage leads is provided. The method of the second embodiment includes the steps of providing an interface and utilizing the interface to collect and aggregate a plurality of mortgage leads from a plurality of mortgage lead suppliers. The method further includes the step of operating the interface to allocate and distribute the collected and aggregated mortgage leads to a plurality of mortgage lead buyers such that the mortgage leads collected from each mortgage lead supplier are allocated and distributed to different ones of the mortgage lead buyers, and the mortgage leads distributed to each mortgage lead buyer are received from different ones of the mortgage lead sources.

In a third embodiment of the present invention, a still further automated, computerized method for processing mortgage leads is provided. This further method according to the present invention includes the steps of pre-selling a fixed number of mortgage leads for distribution over a preselected period of time to each of a plurality of mortgage lead buyers, and collecting and aggregating a plurality of mortgage leads from a plurality of mortgage lead suppliers. The method comprises the further step of allocating and distributing the plurality of mortgage leads to the plurality of mortgage lead buyers as a function of the fixed number of mortgage leads and the preselected period of time.

In a fourth embodiment of the present invention, there is provided a device which comprises an interface and a database coupled to the interface. The database is arranged to store mortgage lead order criteria information and mortgage lead source selection information for each of a plurality of mortgage lead buyers. Pursuant to a feature of the present invention, the interface is arranged and configured to aggregate mortgage leads from a plurality of mortgage lead suppliers, and to use the mortgage lead order criteria information and mortgage lead source selection information stored in the database to allocate and distribute the aggregated mortgage leads to the plurality of mortgage lead buyers.

In accordance with further embodiments of the present invention, the interface further operates to maintain anonymity among and between the plurality of mortgage lead suppliers and the plurality of mortgage lead buyers. An automated, computerized method for processing mortgage leads includes the further steps of collecting mortgage lead rating information and mortgage lead dispute information from the plurality of mortgage lead buyers. The lead rating information can be used to generate return on investment information. In accordance with yet further embodiments of the present invention, computer systems are provided, which include one or more computers configured (e.g., programmed) to perform the methods described above. In accordance with other embodiments of the present invention, computer readable media are provided which have stored thereon computer executable process steps operable to control a computer(s) to implement the embodiments described above.

### BRIEF DESCRIPTION OF THE DRAWINGS

FIG. 1 is a block diagram of an exemplary computer system that can be used to implement embodiments of the present invention for the automated processing of mortgage leads.

FIG. 2 is a block diagram illustrating the supply side of the exemplary computer system of FIG. 1.

FIG. 2a is an additional block diagram of the supply side of the exemplary computer system of FIG. 1, illustrating an upload coupling.

FIG. 3 is a block diagram illustrating the buy side of the exemplary computer system of FIG. 1.

FIG. 4 is a schematic flow chart illustrating a mortgage lead buying process, according to an exemplary embodiment of the present invention.

FIG. 5 is an illustration of a representative web site interactive screen for obtaining order criteria information in a registration process according to an exemplary embodiment of the present invention.

FIG. 6 is an illustration of a representative web site interactive screen for reporting a supplier selection and lead allocation according to an exemplary embodiment of the present invention.

FIG. 7 is a schematic flow chart illustrating a mortgage lead parsing process, according to an exemplary embodiment of the present invention.

FIG. 8 illustrates an order chart for a particular date.

FIG. 9 illustrates a representative web site interactive screen for mortgage lead order history and status.

FIG. 10a illustrates a representative web site interactive screen for mortgage lead dispute resolution, for a mortgage lead buyer, according to a feature of the present invention.

FIG. 10b illustrates a representative web site interactive screen for mortgage lead dispute resolution, for a mortgage lead supplier, according to a feature of the present invention.

### DETAILED DESCRIPTION OF THE PREFERRED EMBODIMENTS

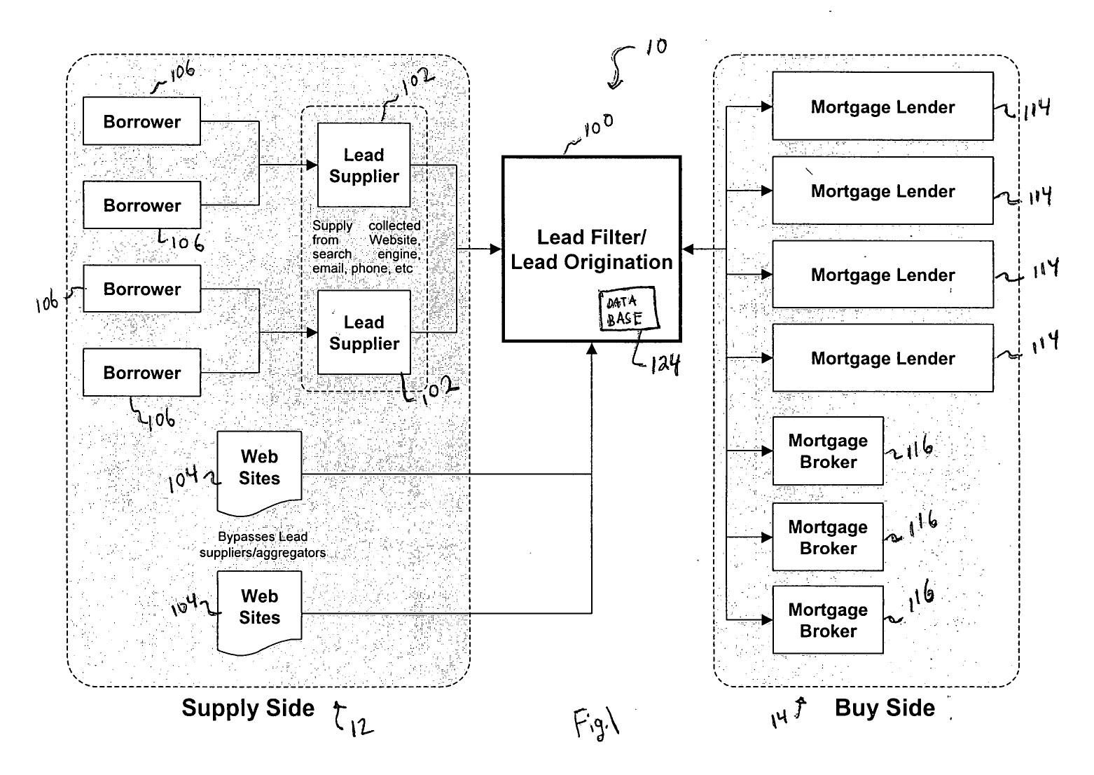

Referring now to the drawings, and initially to FIG. 1, there is shown a block diagram of an exemplary computer system 10 implementing a preferred embodiment of the present invention for the automated processing of mortgage leads. In accordance with an exemplary embodiment of the present invention, a mortgage lead filter/origination interface 100 is arranged to be coupled to each of a plurality of mortgage lead suppliers 102. The mortgage lead filter/origination interface 100 can comprise a computer, such as a commercially available computer server. Each mortgage lead supplier 102 is provided with, for example, a desk top computer electronically coupled to the server computer of the mortgage lead filter/origination interface 100 by any suitable mechanism, such as the internet. Moreover, internet web sites 104 can be directly coupled to the mortgage lead filter/origination interface 100, also via the internet.

Each of the mortgage lead suppliers 102 is, in turn, coupled to prospective borrowers 106, who are solicited or contacted by one of the mortgage lead suppliers 102, either directly or through intermediary parties, to obtain mortgage loan interest information. In addition, the web sites 104 are arranged to respond to internet user inquiries regarding mortgage loans, and prompt users to provide preselected mortgage loan interest information. The mortgage lead suppliers 102, web sites 104 and borrowers 106 comprise a mortgage lead supply side configuration 12 of the computer system 10.

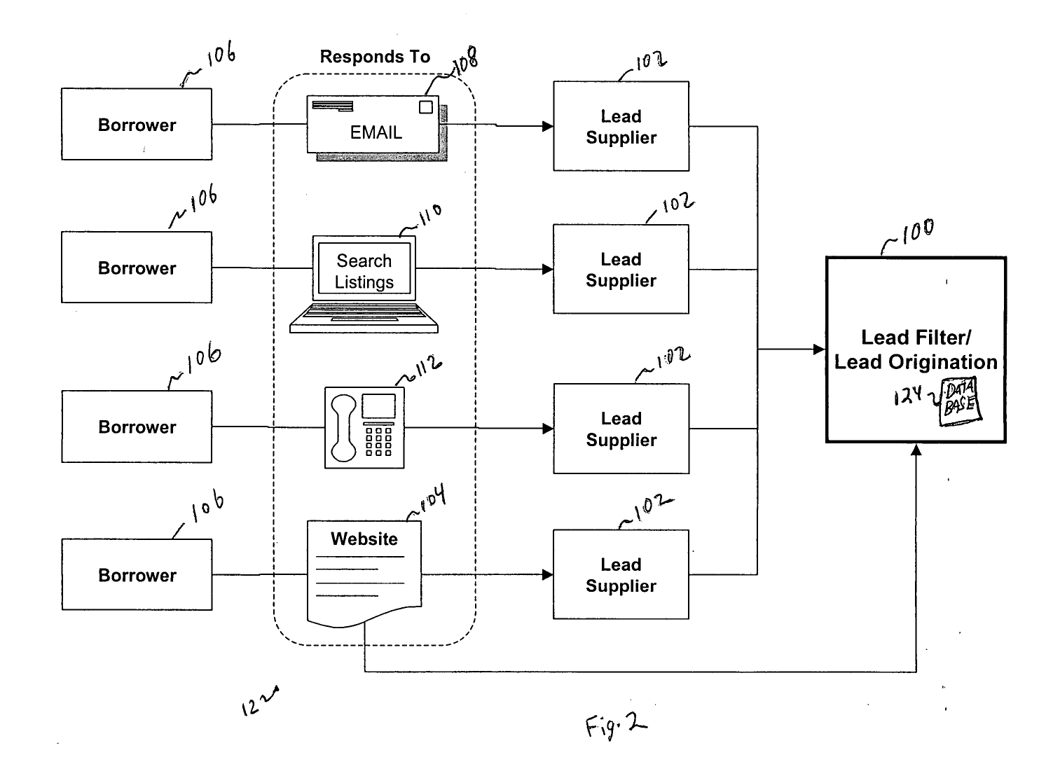

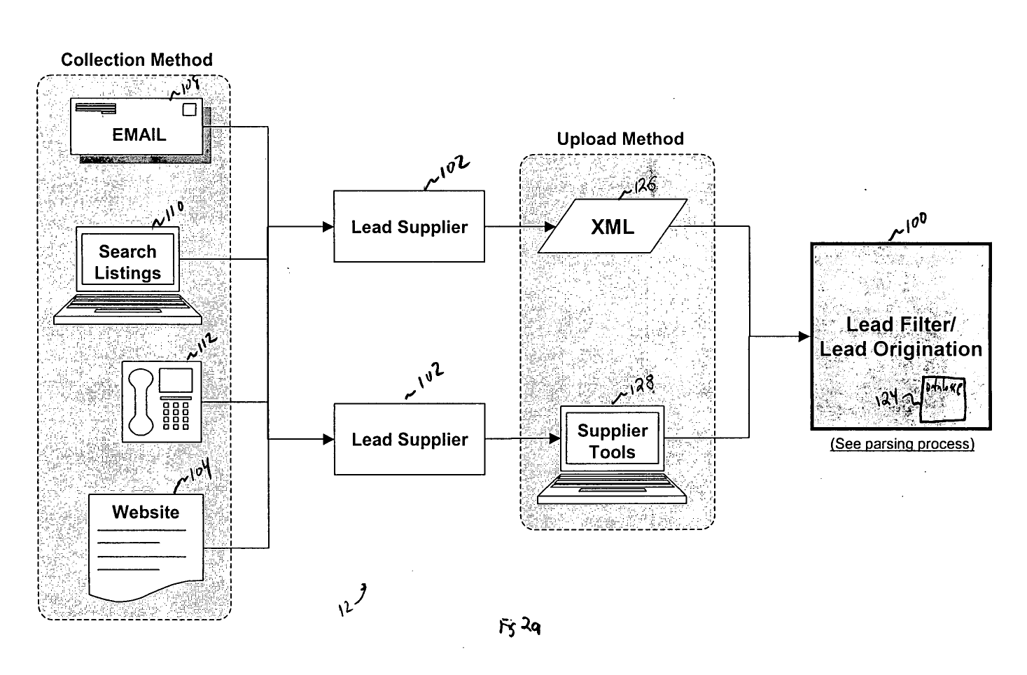

As shown in FIG. 2, in the supply side configuration 12, the mortgage lead suppliers 102 can be coupled to the borrowers 106 via various mechanisms such as email 108, internet search listings 110, telephonic communication 112, or one of the web sites 104. As noted above, and as illustrated in FIG. 2, the web sites 104 can also be directly coupled to the mortgage lead filter/origination interface 100 via the internet. The mortgage lead suppliers 102 are typically direct marketing firms with expertise in obtaining contact with individuals who have an immediate interest in obtaining a mortgage. The mortgage lead suppliers 102, or their intermediaries, obtain detailed mortgage information from the prospective borrowers 106 with whom they have made contact via the various technologies, such as email 108, internet search listings 110, web sites 104 or direct telephone contact 112. The web sites 104 that are directly coupled to the interface 100 are sponsored by internet service providers that can advise large numbers of subscribers of the availability of mortgage services to induce prospective mortgage customers to access the web site 104. The information obtained from prospective, in-market borrowers includes such items as personal address, telephone number and email information, credit rating, amount and type of loan desired, location of the property, and so on. Information provided by the borrowers 106 is collected by each lead supplier 102, and formatted according to a uniform mortgage lead data form for transmission as a mortgage lead to the mortgage lead filter/origination interface 100.

A sample uniform mortgage lead data form can be formatted as follows:
SOURCE: Supplier A
DATE: 15 JUL. 2004
NAME: John Smith
ADDRESS: 123 Main Street, Anywhere, CA
EMAIL: Smith@xxx.com
HOME PHONE: 415-555-1234
WORK PHONE: 415-555-2345
BEST TIME: Evening
LOAN TYPE: Refinance
LOAN AMOUNT: 130,000
PROPERTY TYPE: Single Family Home
PROPERTY VALUE: 150,000
AMOUNT PAID: 100,000
YEAR BOUGHT: 1985
FIRST MORTGAGE BALANCE: 125,000
FIRST MORTGAGE MONTHLY PAYMENT: 945
FIRST MORTGAGE RATE: 7%
FIRST MORTGAGE TYPE: 30 YR FIXED
CREDIT: Good
EMPLOYER: Acme Concrete
YEARS THERE: 3
ANNUAL INCOME: 31,000

As illustrated in FIG. 2a, the transmission of the mortgage leads to the mortgage lead filter/origination interface 100 can be accomplished via different technologies. For example, a lead supplier 102 can transmit lead data as an XML file 126, to the mortgage lead filter/origination interface 100 via the internet. In the alternative, the mortgage lead filter/origination interface 100 can maintain a supplier tool 128 as a web site on the internet that can be accessed by an individual lead supplier 102 for communication of mortgage lead information to the interface 100.

Referring once again to FIG. 1, the mortgage lead filter/origination interface 100 is also coupled to a plurality of mortgage lead buyers such as mortgage lenders 114 and mortgage brokers 116. The mortgage lenders 114 can be financial institutions such as banks, savings and loan associations and other financial institutions. Each of the mortgage lenders 114 and mortgage brokers 116 comprises, for example, a desk top computer coupled to the interface 100. The mortgage lenders 114 and mortgage brokers 116 comprise a mortgage lead buy side configuration 14 of the computer system 10.

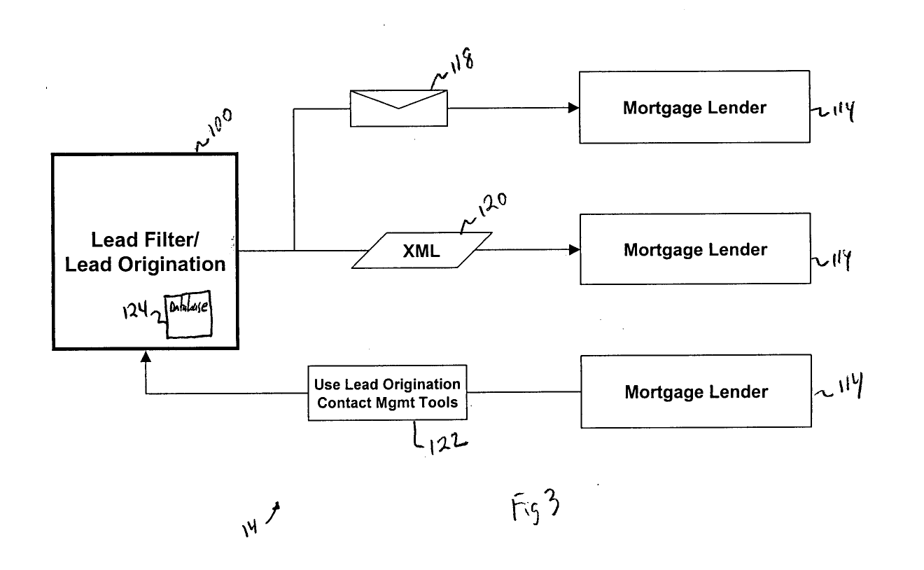

As shown in FIG. 3, in the buy side configuration 14, the coupling between the mortgage lead filter/origination interface 100 and, for example, the mortgage lenders 114 can comprise any number of different technologies that can be selected by each individual mortgage lender 114, so that each mortgage lead buyer can communicate in a manner suitable to the particular lead buyer.

A particular mortgage lender 114 may, for example, desire to communicate with the mortgage lead filter/origination interface 100 via email 118, or an XML file 120 over the internet. In the alternative, similar to the arrangement implemented on the supply side 12 of the computer system 10, the mortgage lead filter/origination interface 100 can maintain a use lead origination contact management tool 122 as a web site on the internet that can be accessed by an individual mortgage lender 114 or mortgage broker 116 for communication with the interface 100, as will be described.

Thus, according to the present invention, the mortgage lead filter/origination interface 100 provides a conduit for the collection, aggregation, filtering, allocation and transmission of mortgage leads generated and collected by a plurality of lead suppliers 102 and web sites 104 and distributed to a plurality of mortgage lenders 114 and mortgage brokers 116. Pursuant to a feature of an exemplary embodiment of the present invention, the mortgage lead filter/origination interface 100 includes a database 124 arranged to archive the mortgage leads submitted by mortgage lead suppliers 102, and maintain mortgage lead information on each lead supplier 102, web site 104, mortgage lender 114 and mortgage broker 116 coupled to the interface 100. The information stored in the database 124 enables the interface 100 to filter and parse the mortgage leads and lead information dynamically to provide an allocation and distribution of mortgage leads such that the leads from each of the plurality of mortgage lead suppliers 102 can be selectively distributed to a plurality of different mortgage lenders 114 and/or mortgage brokers 116, and each mortgage lender 114 and/or mortgage broker 116 can receive relevant mortgage leads from a plurality of different mortgage lead suppliers 102. This arrangement is highly suitable for providing a liquid marketplace, and a reliable source of diverse and high quality mortgage leads for lead buyers.

Referring once again to FIG. 2a, mortgage leads collected by each lead supplier 102 from borrowers 106 are uploaded into the database 124, for example, on a daily basis, via one of the upload mechanisms provided by the XML files 126 and the supplier tool web site 128. Initially, each lead supplier 102 submits registration information to the interface 100 for loading into the database 124, including address and email information, an indication of the type of lead generation offered by the lead supplier 102, a description of the method of lead generation utilized by the lead supplier 102, whether the leads are offered on an exclusive or non-exclusive basis, the asking price per lead, and the number of leads the lead supplier 102 would be able to generate on a daily basis. The registration process also includes an agreement by the lead supplier 102 to provide a daily upload of leads in the number specified by the supplier 102. The types of lead generation can include such indications as “telephone generated leads” and/or “internet generated leads.” An Exclusive lead is one that the supplier agrees to sell only once to a single mortgage lender 114 or mortgage broker 116. A non-exclusive lead can be sold to a number of different mortgage lenders 114 or mortgage brokers 116, typically limited to, for example, four different sales. The descriptions can include a brief paragraph, such as, for example, “Supplier generates EXCLUSIVE qualified mortgage leads through the process of targeting homeowners and conducting a 30+question form with verification.”

According to a feature of the present invention, the interface 100 operates to assign a source identification (ID) to each mortgage lead supplier 102, such as “Source A.” The use of an ID permits the system to maintain anonymity for the mortgage lead suppliers 102 in lead sale transactions. Each registered lead supplier 102 also selects a screen name and password to permit future access to the interface 100 for the uploading of lead information.

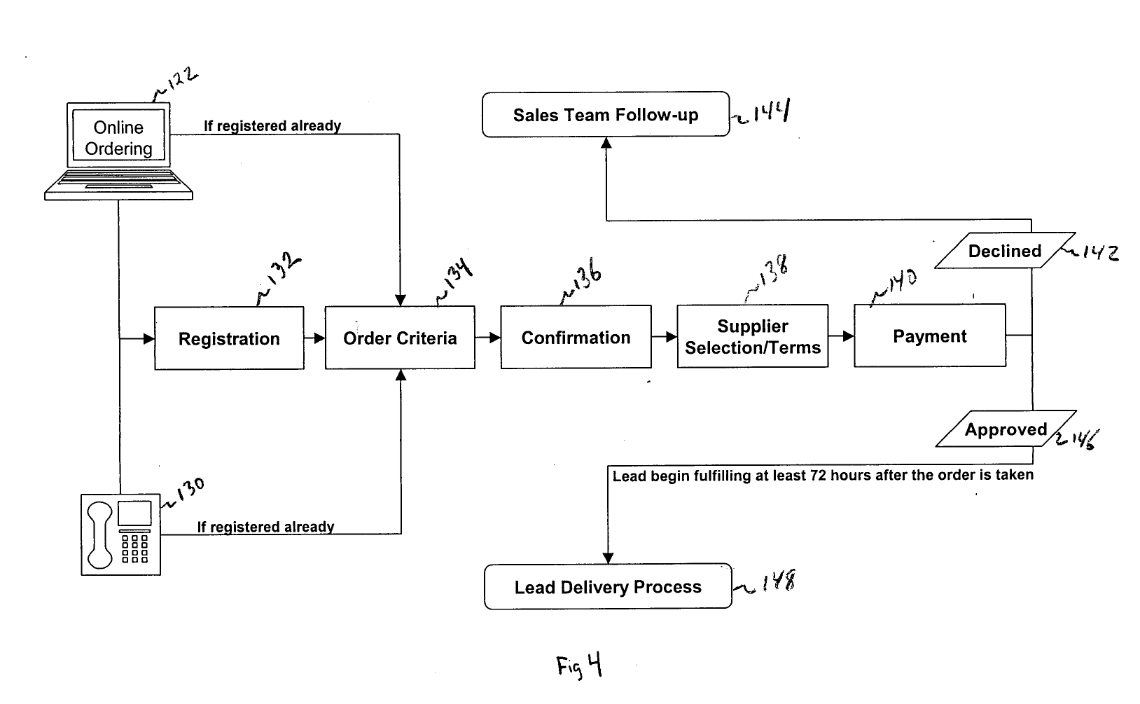

A registration and lead buying process is also implemented to provide for a pre-sale of leads and to load the database 124 with information relevant to mortgage lead requirements of the mortgage lenders 114 and mortgage brokers 116 coupled to the interface 100. As illustrated in FIG. 4, each mortgage lender 114 and mortgage broker 116 desiring to register on the interface 100 can access the interface 100 via the web site 122 described above, or by telephone 130. In the registration process 132, similar to the registration of mortgage lead suppliers 102, each mortgage lender 114 and mortgage broker 116 provides registration information, such as address and email information, and selects a screen name and password to permit access to the interface 100. When using the telephone, a sales team representative would query the mortgage lender 114 or mortgage broker 116 for the information and access the interface 100 on behalf of the caller to input the information. The interface 100 generates an account number to identify the particular mortgage lender 114 or mortgage broker 116 as well as to maintain anonymity for the lead buyers in lead purchase transactions. The mortgage lender 114 or mortgage broker 116 in the process of registering is then prompted to provide order criteria information 134.

When a mortgage lender 114 or mortgage broker 116 is already registered, but desires to modify the related order criteria information, the mortgage lender 114 or mortgage broker 116 can access the interface 100 directly at the order criteria information stage 134 of the interface 100, as shown in FIG. 4.

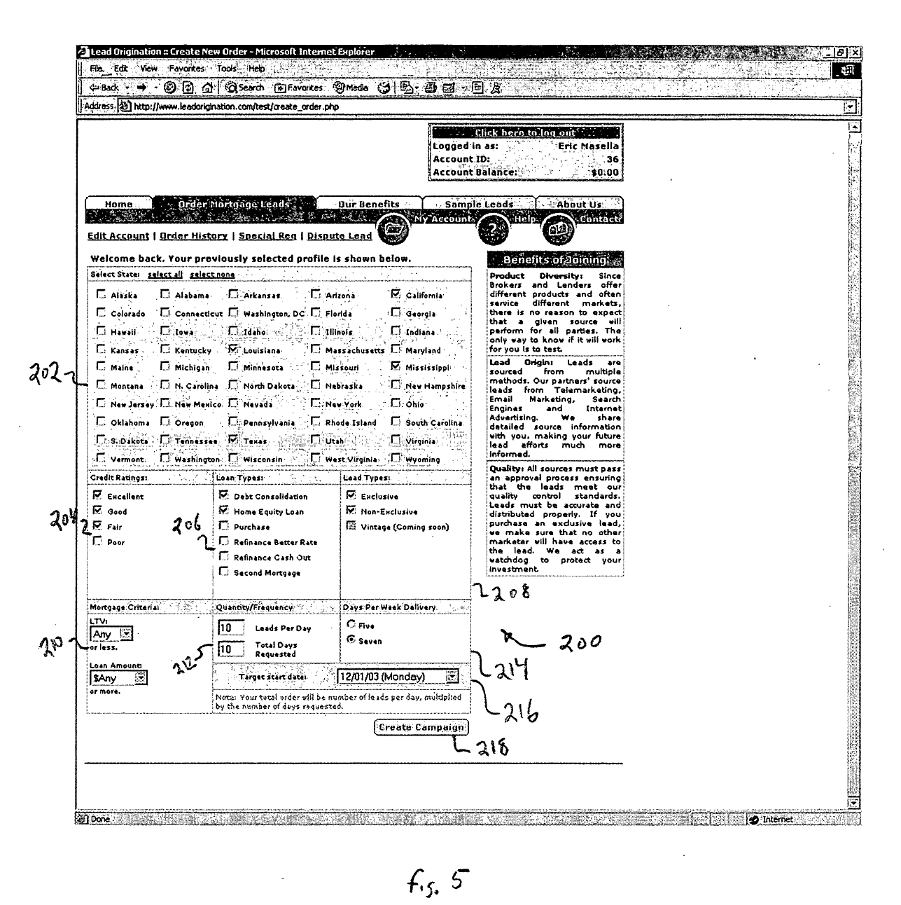

Referring now to FIG. 5, there is shown an illustration of a representative web site interactive screen 200 for obtaining order criteria information. The screen 200 comprises a set of selection boxes, including “Select States” 202, “Credit Ratings” 204, “Loan Types” 206, “Lead Types” 208, “Mortgage Criteria” 210, “Quantity/Frequency” 212, “Days Per Week Delivery” 214, and “Target Start Date” 216. Each of these selection boxes provides a selection choice mechanism, such as a check box, so that each mortgage lender 114 and mortgage broker 116 can select criteria relevant to their mortgage lead requirements.

To that end, the Select State selection box 202 includes a list of all 50 states, each with a check box. A mortgage lender 114 or mortgage broker 116 can check off the check box in front of each state that it does business and would want to receive mortgage leads. In the example of FIG. 5, the boxes for Louisiana, Texas, California and Mississippi are checked off. Thus, a mortgage lender 114, for example, would receive leads only for mortgages to be secured by a property in one of these states.

As shown in FIG. 5, the Credit Ratings box 204 provides choices of Excellent, Good, Fair and Poor. Thus, a mortgage lender 114 or mortgage broker 116 can select leads only from prospective customers who have a credit rating equal to one or more of the listed credit ratings. In the illustrated example of FIG. 5, the boxes for Excellent, Good and Fair have been checked.

In the Loan Types box 206 are selections of Debt Consolidation, Home Equity Loan, Purchase, Refinance Better Rate, Refinance Cash Out and Second Mortgage. The present example shows Debt Consolidation and Home Equity Loan selected.

In the Lead Types box 208 are selections for Exclusive and Non-Exclusive. In the example of FIG. 5, both Exclusive and Non-Exclusive are checked.

In the Mortgage Criteria box 210, there are selections for Loan to Value Ratio (LTV) and Loan Amount. A mortgage lender 114 or mortgage broker 116 can select and enter a specific ratio and dollar amount, respectively, or select “Any” for each selection. The loan to value ratio is a standard ratio used in the mortgage industry. The present example shows a selection of Any in each case.

According to a feature of the present invention, The Quantity/Frequency and Days Per Week selection boxes 212, 214 permit a mortgage lender 114 or mortgage broker 116 to select a volume and frequency of mortgage lead delivery via the operation of the mortgage lead filter/origination interface 100. The Quantity/Frequency box 212 provides for the entry of a specific number of Leads Per Day, and Total Days requested. In the illustrated example, “10” is selected for each category. Thus, the mortgage lender 114 or mortgage broker 116 has selected 10 leads per day for 10 days for a total amount of 100 leads. The Days Per Week Delivery box 214 allows the mortgage lender 114 or mortgage broker 116 to specify whether the leads are to be delivered seven days a week (Seven), or just week days (Five). In the example, Five has been selected.

In the Target Start Date box 216, the mortgage lender 114 or mortgage broker 116 can enter a date upon which the lead deliveries are to start. For convenience, the start date can be set at, for example, a minimum of at least seventy hours after submitting the order information. This provides an adequate amount of time to process the new order information and alert lead suppliers 102 of lead generation requirements.

A Create Campaign button 218 is provided whereby the mortgage lender 114 or mortgage broker 116 can click on the button 218 when all the information required by the screen 200 has been entered. The button 218 serves to cause the transmission of the information to the interface 100 for loading into the database 124. All of the submitted information establishes a profile for the particular mortgage lender 114 or mortgage broker 116, that can be used as a basis to screen mortgage leads in a lead matching process, as will be described.

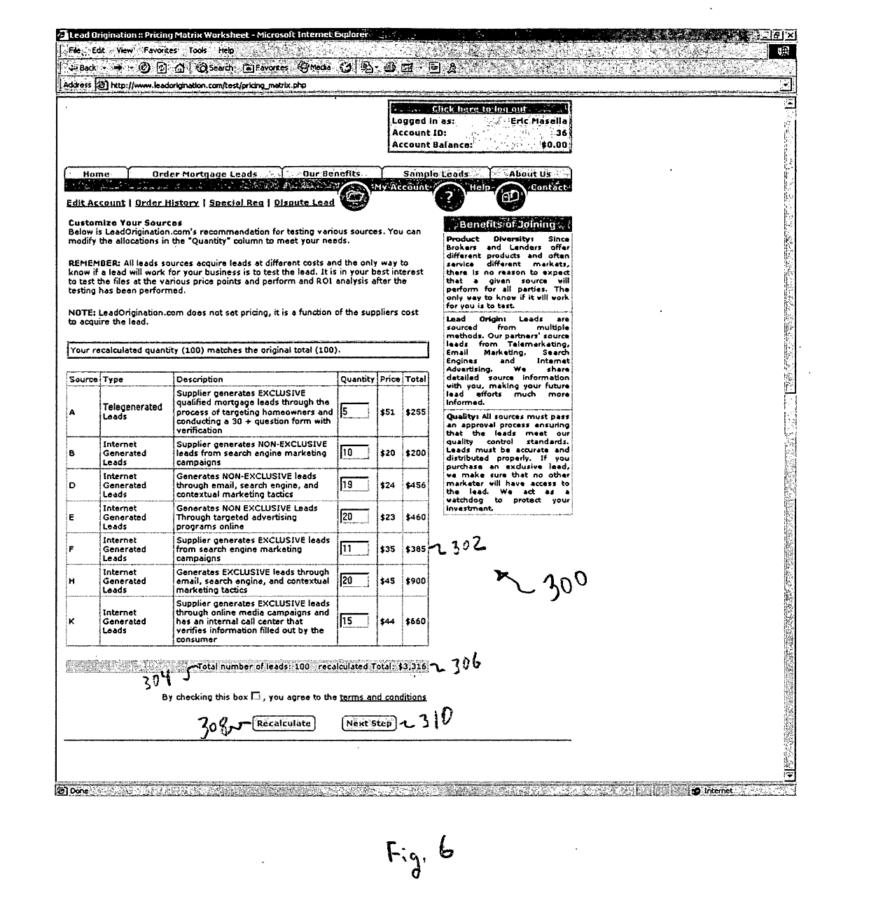

Upon receipt of the submitted information, the mortgage lead filter/origination interface 100 transmits a confirmation 136 to the mortgage lender 114 or mortgage broker 116 who submitted the information, to acknowledge receipt. The interface 100 also transmits a supplier selection information screen 138 to the respective mortgage lender 114 or mortgage broker 116. In FIG. 6 there is shown a representative web site interactive screen 300 for reporting a supplier selection and lead allocation according to an exemplary embodiment of the present invention. The screen includes a chart 302 comprising six columns labeled “Source,” “Type,” “Description,” “Quantity,” “Price,” and “Total.” The Source column identifies each mortgage lead supplier 102 selected by the interface 100, by the corresponding ID assigned by the interface 100, for example, A, B, D etc. The Type column indicates the type of lead generation utilized by the respective lead supplier 102, and the Description column sets forth the descriptive paragraph submitted by the respective mortgage lead supplier 102 during the registration process. Similarly, the Price column sets forth the price per lead indicated by the corresponding mortgage lead supplier 102 during registration. The price per lead can be increased by a fixed amount, in each instance, to provide a fee for use of the interface 100 to obtain leads. The interface 100 obtains the information for the above described columns of the supplier selection screen 300 from the database 124.

According to a feature of the present invention, the amount indicted for each mortgage supplier 102 in the Quantity column of the supplier selection screen 300 is generated by the mortgage lead filter/origination interface 100 as a function of the number of leads requested by the particular mortgage lender 114 or mortgage broker 116 in the corresponding order criteria information screen 200 submitted to the interface 100, and the number of leads per day that can be generate on a daily basis, as indicated by each of the mortgage suppliers 102 during registration.

More specifically, the interface 100 operates to add the daily lead generation numbers for all the registered suppliers 102 to determine a total amount of leads that can be generated by all registered mortgage lead suppliers 102, on a daily basis. Then, the interface 100 calculates a percentage of lead generation for each registered mortgage lead supplier 102 by dividing the daily number of leads specified by a particular mortgage lead supplier 102 by the total amount of daily lead generation. Thus, by way of example, if source A indicated that it can generate up to 50 leads per day, and the total amount of leads is determined to be 1000 leads, then the percentage for source A would be 5%.

Accordingly, in our example, since the mortgage lender 114 or mortgage broker 116 submitting the order criteria information screen 200 of FIG. 5 selected 10 lead per day for 10 days for a total of 100 mortgage leads, and the calculated percentage for source A is 5%, the Quantity specified on the screen 300 for source A would be 5, indicating the number of leads of the total order that are to be supplied by source A (5% of 100 equals 5). Similar calculations are made by the interface 100 for each source listed in the Source column, and the results are indicated in the Quantity column of the screen 300. The number specified in the Quantity column for each supplier 102 is multiplied by the Price indicated for the corresponding mortgage supplier 102 to determine a Total cost for the leads from the particular supplier 102, indicated in the Total column. The interface 100 also operates to calculate a Total number of leads 304, and total cost for the mortgage lead order 306.

Pursuant to a feature of the present invention, the amounts specified by the interface 100 in the quantity column can be modified by the submitting mortgage lender 114 or mortgage broker 116 as a mechanism for improving lead quality. For example, if due to the experience of a particular mortgage lender 114 or mortgage broker 116, it is learned that the leads it has obtained from sources A, E and F are of high value, typically leading to a high percentage of loan deals, and the leads obtained from, for example, source K are generally of low quality, then the particular buyer can split the 100 leads among sources A, E and F, and zero out the quantities of the remaining sources, including source K. Upon completing the modification, a mortgage lender 114 or mortgage broker 116 would select a Recalculate button 308. This will cause the interface 100 to recalculate the values displayed in the screen 300. When the particular mortgage lender 114 or mortgage broker 116 is satisfied with the allocation of leads among the mortgage lead suppliers 102, as shown on the screen 300, then a Next Step button 310 can be selected to cause the interface 100 to assign an order number for the order criteria screen 300, and then proceed onto a payment process 140 (see FIG. 4).

According to the present invention, subsequent to the completion and submission of the order criteria information screen 200 and approval and submission of the source selection screen 300 by a particular mortgage lender 114 or mortgage broker 116, the mortgage lender 114 or mortgage broker 116 submitting the order criteria information is prompted by the interface 100 to submit payment information 140, such as, for example, credit card information. The interface 100 processes the credit card information to charge the mortgage lender 114 or mortgage broker 116 for the total number of leads requested in the order criteria screen 200. In the event that the credit card charge is declined 142 by the corresponding credit card company, the order is submitted to a sales team follow-up 144, for further inquiry. On the other hand, in the event that the credit card charge is approved by the corresponding credit card company, the mortgage lead filter/origination interface 100 credits the respective account number, and proceeds to a lead delivery process 148. This results in a pre-sale of the entire order, prior to delivery of the mortgage leads.

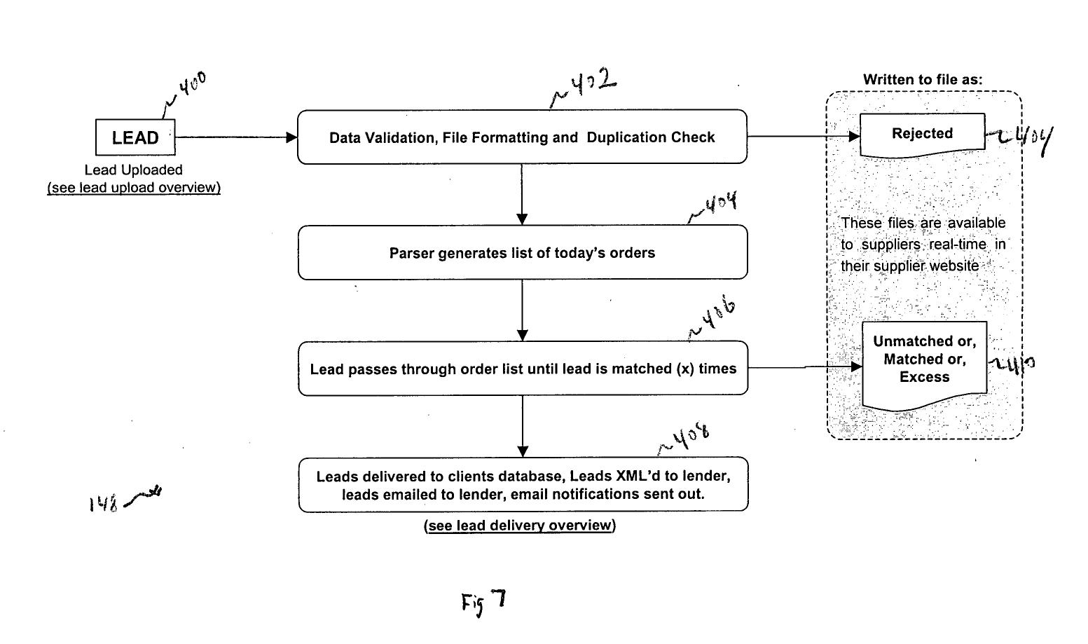

Referring now to FIG. 7, there is shown a schematic flow chart illustrating a mortgage lead parsing process of the lead delivery process 148, according to an exemplary embodiment of the present invention. As described above, all of the leads generated by a supplier 102 during a day are uploaded to the database 124, via one of the upload methods illustrated in FIG. 2a, including, for example, use of one of XML files 126 or the supplier tool web site 128. The uploaded leads 400 are each given a unique lead ID, including an indication as to which mortgage lead supplier 102 uploaded the lead. The uploaded leads are then stored in the database 124 for archiving, parsing and filtering operations. The mortgage lead filter/origination interface 100 operates to parse the database 124 to filter the uploaded leads, based upon a data validation, file format and duplication check. The leads can be processed real time upon uploading from the mortgage lead suppliers 102. The data validation and file formatting function reviews each lead to insure that the format used by the supplier 102 is correct, for example, the lead format conforms to a standard form such as the sample lead shown in paragraph 28, and that proper values are supplied in each field of the form. The interface 100 also checks for duplicate leads, for example by checking for duplicate telephone numbers among the uploaded leads. Any lead that is found to be non-conforming, missing data and/or a duplicate of another lead is rejected, and listed in a rejected lead file 404 in the database 124.

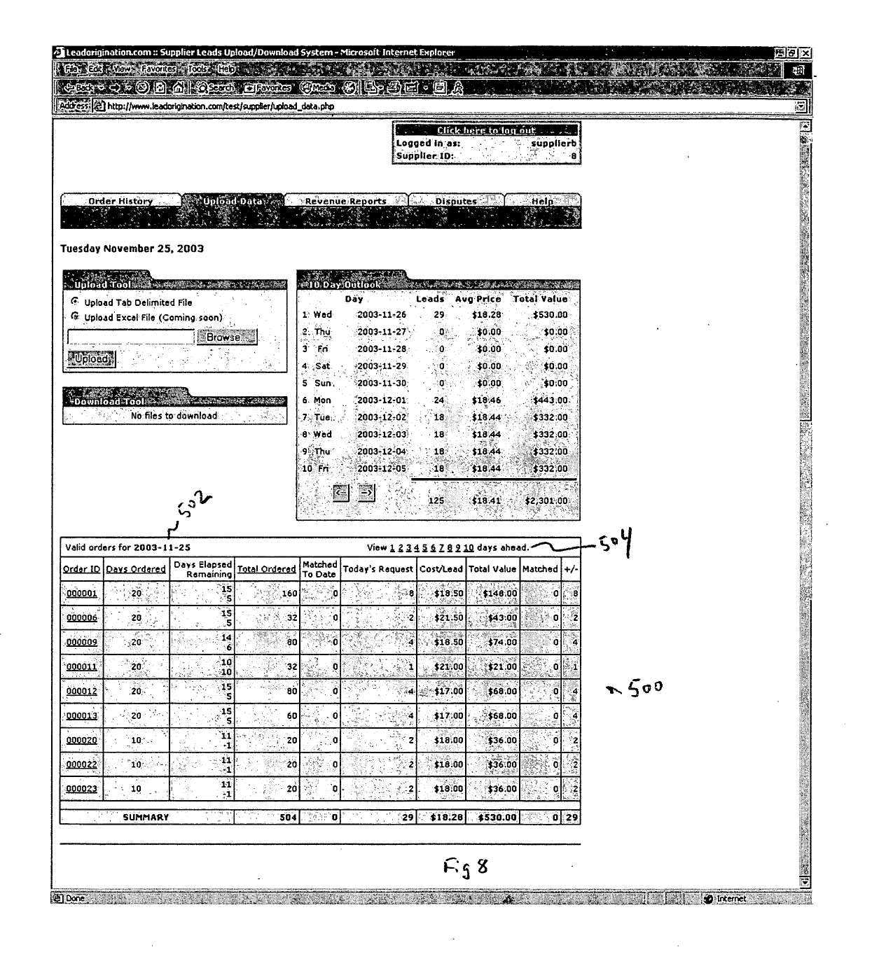

In accordance with an exemplary embodiment of the present invention, the mortgage lead filter/origination interface 100 operates to generate a list of a current days orders 404, as determined from the order criteria information and source selection submitted by each mortgage lender 114 and mortgage broker 116 coupled to the interface 100. FIG. 8 provides a sample chart 500 for listing all orders requesting the delivery of mortgage leads for a particular date. The chart 500 is electronically generated and maintained by the interface 100. The chart 500 can be accessible as a web site, via the internet. As shown in the chart 500, there are ten columns labeled “Order ID,” “Days Ordered,” “Days Elapsed/Remaining,” “Total Ordered,” “Matched to Date,” “Today's Request,” “Cost per Lead,” “Total Value,” “Matched,” and a running tally indicated by “+/−.” The top of the chart 500 indicates the date 502 represented by the chart 500. The chart 500 also includes a feature of permitting a user to view the chart 500 via the web site, for any day, for up to, for example, ten days into the future 504 by clicking on a day number.

Each order ID corresponds to a particular order criteria information screen 200 and source selection screen 300 submitted by one of the mortgage lenders 114 or mortgage brokers 116 coupled to the interface 100. Accordingly, the mortgage lead filter/origination interface 100 can access the corresponding lead information in the database 124 for generating information for each of the other columns of the chart 500, and for matching each uploaded lead to a lead buyer, as will appear. The Days Ordered column indicates the total number of days ordered by the respective mortgage lender 114 or mortgage broker 116, as indicated in the Quantity/Frequency box 212 of the corresponding order criteria information screen 200. The Days Elapsed/Remaining column is generated by the interface 100 from the date of the chart 502 and the start date selected by the respective mortgage lender 114 or mortgage broker 116 in the Target Start date box 216. The upper number is the number of days of the order that have elapsed since the start date, and the lower number represent the number of remaining days for the order.

Similar to the Days Ordered column, the information for the Total Ordered, Today's Request, Cost per Lead and Total value can be determined by the interface 100 via reference to the corresponding order criteria information screen 200 and source selection screen 300, as stored in the database 124. The remaining columns are maintained dynamically by the interface 100 in real time, as uploaded leads are matched. For example, as a lead is matched to an order, the matched column is incremented, and the value in the +/−column is decremented. In this manner, the interface 100 can record and track order fulfilment, and debit the respective account credit of the respective mortgage buyer, as a charge for the matched lead, and further credit an account for the source of the lead, as payment for the lead.

Referring once again to FIG. 7, after generation of the chart 500, the mortgage lead filter/origination interface 100 proceeds to pass each uploaded lead through the list of the chart 500 in a matching process 406. The matching operation can be completed real time as leads are uploaded by the mortgage lead suppliers 102. The interface 100 compares various fields from each of the order criteria information screen 200 and source selection screen 300 of each order, with fields of the uploaded lead. For example, the state of residence, loan type, loan amount and credit rating of an uploaded lead can be compared to the information of the Select States 202, Credit Ratings 204, Loan Types 206, and Loan Amount 210 boxes of the order criteria information screen 200, and the Source and Quantity columns of the Source Selection screen 300 of a respective mortgage lender 114 or mortgage broker 116.

In accordance with a feature of the present invention, a mortgage lead buyer prioritization scheme is implemented to achieve a lead match rate optimization. Each mortgage lender 114 and mortgage broker 116 is ranked as a function of selectivity in the corresponding order criteria information screen 200. Thus, a mortgage lead buyer interested in many different types of leads from many different states, has low selectivity, and would be assigned a low priority. This is because many of the uploaded leads would have a good probability of a successful match, and an improved match rate can be achieved by first attempting to match leads to more selective mortgage lead buyers. To that end, for example, a mortgage lead buyer who selects all 50 states (low selectivity) in the corresponding Select States 202 box would have a lowest priority for that factor, since all leads would match that factor for that buyer, while a mortgage lead buyer who selects only one state in its corresponding Select States 202 box (high selectivity) would have a highest priority, since only a limited subset of all leads would match.

Similar priority ratings are determined for each mortgage lead buyer, for each selection box of the corresponding order criteria information screen 200 (for example, the Select States 202, Credit Ratings 204, Loan Types 206, and Loan Amount 210 boxes), and a composite priority for each particular mortgage lead buyer can be derived, for example, as an average of the priorities. The interface 100 operates to match each uploaded lead to the mortgage lenders 114 and mortgage brokers 116, in order of their respective priorities. Thus, for example, regarding a lead for California, the interface 100 will attempt to match the lead first to mortgage lead buyers who selected only California, and thereafter to other mortgage lead buyers, in descending priority order.

Upon a complete match for a lead, the interface 100 lists the lead for delivery 408 to the corresponding mortgage lender 114 or mortgage broker 116. The Matched and +/−columns for the order are also updated. The interface 100 can also track the match, and remove the lead from further matching analysis if matched and designated an exclusive lead, or increment a match count for the uploaded lead if designated a non-exclusive lead. The count for the non-exclusive lead can be capped at a maximum number, for example, four. When the match count reaches four, the interface then removes the uploaded non-exclusive lead from further matching analysis. In the event that an uploaded lead does not find a match in any of the orders for the day, the lead is marked unmatched. Also, all leads remaining after all orders have been satisfied are labeled excess.

All unmatched, matched and excess leads are listed and labeled 410 in the database 124. All leads listed 404, 410 in the database 124 can be accessed by a mortgage lead supplier 102 on the supplier tools web site 128, so they can track disposition of the leads that the supplier 102 uploaded to the interface 100. Each particular mortgage lead supplier 102 accesses the listed leads by using the corresponding screen name and password, and access can be limited to listed leads uploaded by the particular mortgage lead supplier 102. For listed matched leads, the lead buyer(s) is identified by account number to maintain the anonymity of the buyer.

During the match process, the mortgage lead filter/origination interface 100 tracks the particular sources of matched leads. A count would be made per source per lead, so that the number of leads matched between a particular supplier 102 for any one order does not exceed the number in the Quantity column for the particular supplier 102, in the source selection screen 300 corresponding to the order. Accordingly, the interface 100 operates to assure that each order is satisfied via a plurality of different sources, and with the number of leads per supplier corresponding as close as possible to the number in the Quantity column for that supplier.

To that end, the number of leads per supplier per day is kept as constant as possible. This is achieved by utilizing a rounding calculation. For example, a rounded number of leads per day for a supplier is determined as a function of the number of leads in the Quantity column for that supplier, and the total number of days in the corresponding order. Thus, if a supplier is to deliver 11 leads over 5 days, the rounded number of leads per day would be 2. The rounded number of leads per day is multiplied by the number of days in the order to determine a rounded total. The difference between the rounded total and the actual number of orders is used as a round off on a per day basis. In this example, the difference is +1 (there is 1 more lead in the actual number ordered than in the rounded determined total, if the number of actual leads is less that the rounded total, the difference would be negative). The positive difference is added, starting from the first day of the order, to the rounded per day amount, as evenly as possible, until the difference is accounted for. So, in our example, the 1 would be added to the 2 leads for the first day for a total of 3, and the five days distribution of leads would be 3, 2, 2, 2, 2. In the event of a negative difference, the difference is subtracted from the rounded number for the days until accounted for.

All matched leads listed by the interface 100 are delivered by the interface 100 (408) to the corresponding mortgage lenders 114 and mortgage brokers 116 of the lead match via one of email 118, an XML file 120, or via access to a use lead origination contact management tool on a web site 122, as illustrated in FIG. 3. The particular type of delivery mechanism can be selected by the mortgage lead buyer. In each of the delivered leads, the source is identified by the source ID assigned by the interface 100 to maintain the anonymity of the supplier.

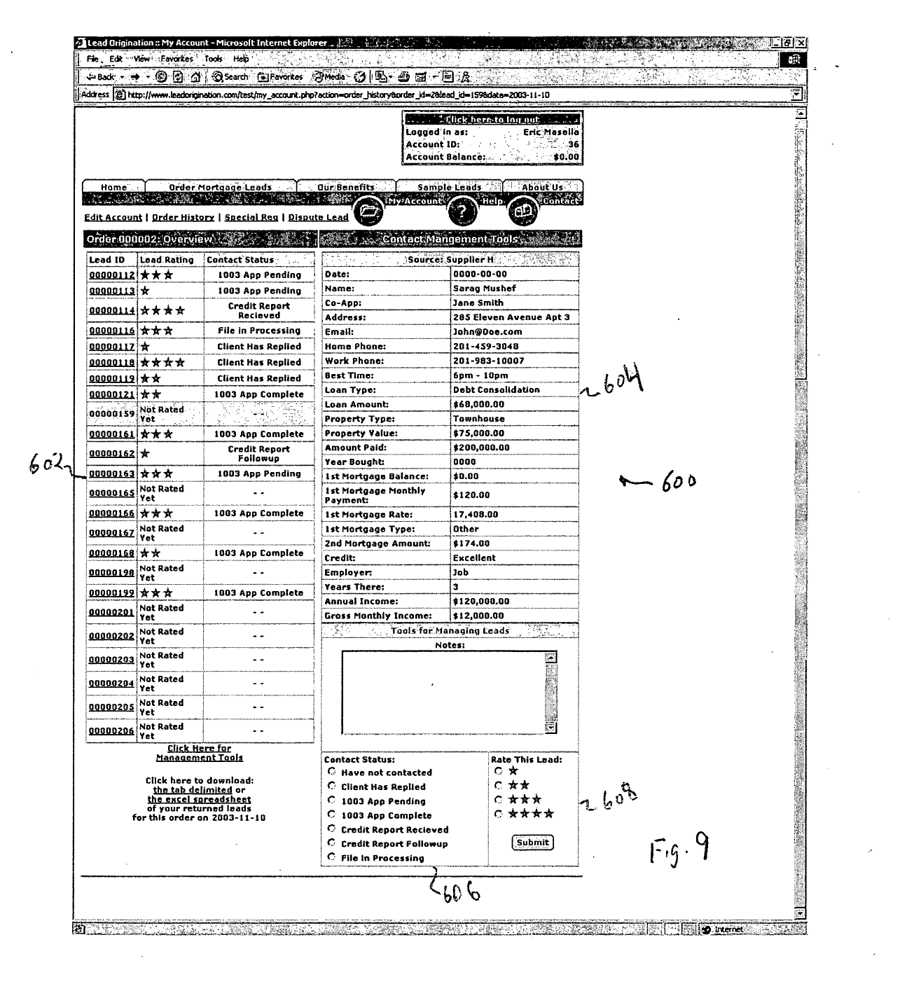

Referring now to FIG. 9, there is shown a representative web site interactive screen 600 for mortgage lead order history and status. The illustrated lead order history and status screen 600 depicts a particular order by order ID, and can be accessed by the mortgage lender 114 or mortgage broker 116 who submitted the particular order, using the screen name and password assigned to the mortgage lead buyer. The screen 600 includes a lead list 602, listing by lead ID all of the leads delivered by the interface 100 pursuant to the order. Next to each ID is a Lead Rating column, and a Contact Status column. After mortgage leads are delivered to a mortgage lender 114 or mortgage broker 116, these columns of the screen 600 can be accessed and used to input and track lead status by the respective mortgage lender 114 or mortgage broker 116. Moreover, upon highlighting a particular lead on the list 602, all details of the corresponding lead are displayed 604 on the screen 600, adjacent to the list 602.

A contact status box 606 contains a series of status statements relevant to the individual identified as a mortgage lead, each provided with a selection indicator that can be selected by the particular mortgage lender 114 or mortgage broker 116. The statements include, for example, “Have not contacted,” and “Client has replied.” Upon highlighting one of the leads in the list 602, and selection or change of a statement by the mortgage lender 114 or mortgage broker 116 in the box 606, the interface 100 updates the lead list.

Similar to the contact status box 606, a Lead Rating box 608 is also provided. The box 608 contains, for example, each of a one star to a four star rating, each provided with a selection indicator that can be selected by the particular mortgage lender 114 or mortgage broker 116. Thus, the buyer of the lead can eventually rate the lead, based upon, for example, success of lead follow-up, to provide an information feedback loop. The interface 100 can utilize feedback information submitted by lead buyers to average all ratings for each particular mortgage lead supplier, and make such rating information available to the mortgage lead buyers.

In this manner, a mortgage lender 114 or mortgage broker 116 can perform a return on investment analysis (ROI) on mortgage lead purchases. The analysis can indicate success rates generated by leads from various suppliers, and enable the mortgage lead buyers to refine supplier selections choices, based upon the ROI, in the supplier selection screen 300.

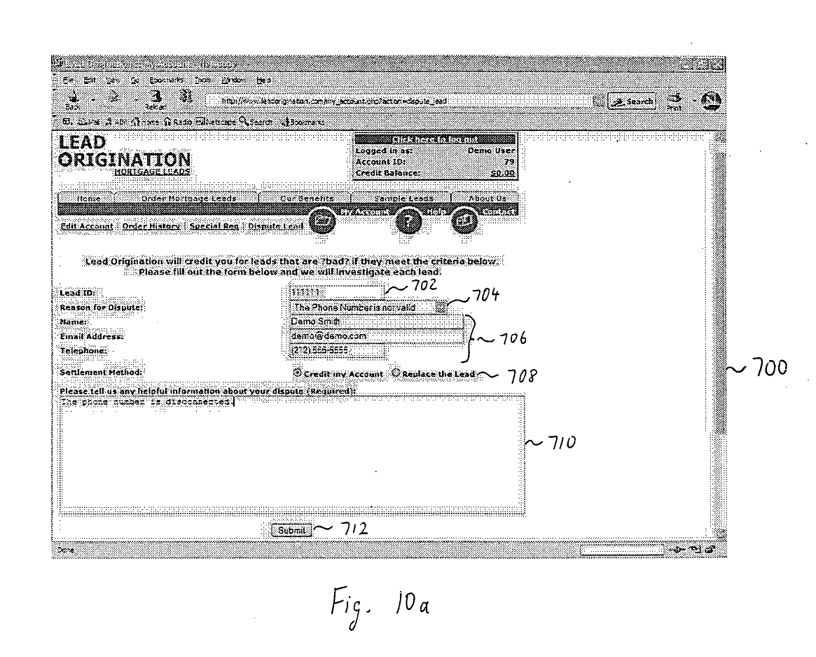

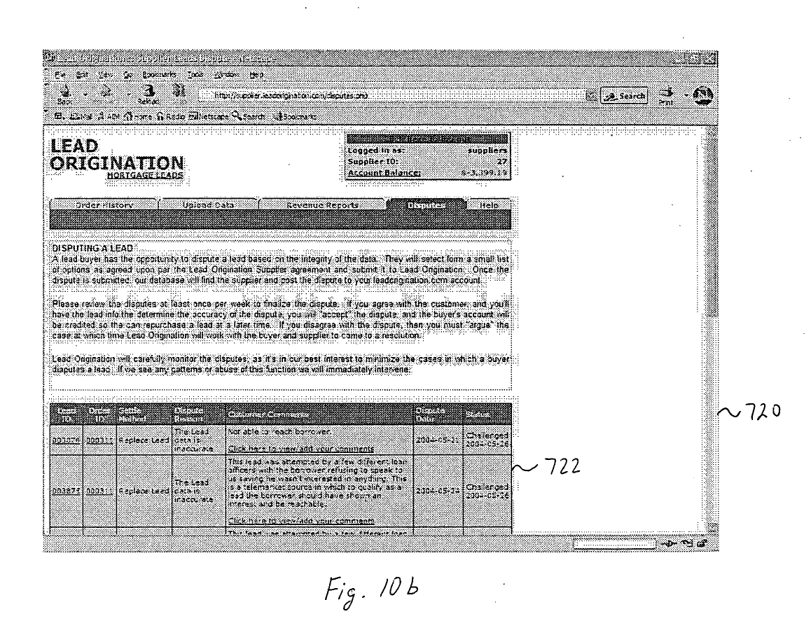

Referring now to FIG. 10a, there is illustrated a representative web site interactive screen for mortgage lead dispute resolution, for a mortgage lead buyer, according to a feature of the present invention. A lead dispute screen 700 comprises a Lead ID box 702 and a Dispute Reason box 704. When a mortgage lender 114 or mortgage broker 116 is dissatisfied with a lead purchased via the interface 100, the buyer can access the web site and select the lead dispute screen 700. The particular mortgage lender 114 or mortgage broker 116 dissatisfied with a lead would then enter the lead ID for the disputed lead into the Lead ID box 702, and then enter a text description of the basis for the dispute in the Dispute Reason box 704. In the example of FIG. 10a, the reason for the dispute is that the phone number is not valid. The lead dispute screen 700 can also include additional information, such as the name, email address, and telephone number of the lead 706. Moreover, the screen 700 is provided with a selection of dispute resolution 708, which includes, for example, the choice of “Credit My Account,” or “Replace the Lead.” There is also a text box 710 where the mortgage lead buyer can further explain the reasons for the dispute. The dissatisfied buyer would thereafter click on a Submit button 712 to transmit the dispute information to the interface 100.

Upon receipt of the dispute information, the interface 100 accesses the database 124 to identify the source of the disputed lead. The interface 100 then transmits the dispute information to the identified mortgage lead supplier 102 for resolution, as will be described with respect to FIG. 10b. The interface 100 can operate as an intermediary party in the dispute resolution to maintain anonymity among the buyers and sellers.

In FIG. 10b, there is illustrated a representative web site interactive screen for mortgage lead dispute resolution, for a mortgage lead supplier, according to a feature of the present invention. A mortgage lead supplier 102 can access a dispute resolution screen 720 that is generated by the interface 100 to communicate lead disputes to the mortgage lead supplier 102. The lead dispute screen 720 includes a chart 722 having seven columns labeled “Lead ID,” “Order ID,” “Settle Method,” “Dispute Reason,” “Customer Comments,” “Dispute Date,” and “Status.” The Lead ID column lists the ID for each lead uploaded by the particular mortgage lead supplier 102, that is being disputed by a buyer. The Order ID column lists the orders that correspond to each disputed lead, respectively. The Settlement Method, Dispute Reason and Customer Comments columns indicate the dispute settlement method selected by the corresponding buyer and the dispute reason and additional comments submitted by the buyer in the box 710 (see FIG. 10a). The Dispute Date is the date the buyer submitted the dispute.

According to the present invention, the Status column permits the mortgage lead supplier 102 to enter a response to the submitted dispute. For example, the particular mortgage lead supplier 102 can enter “accept” or “challenged.” Accept indicates that the mortgage lead supplier 102 accepts the dispute and agrees to a refund or to provide another lead, as selected by the mortgage lead buyer. In the event of a challenge, a representative of the interface 100 can contact the supplier and buyer to handle settlement of the dispute.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. An automated, computerized method for processing mortgage leads, comprising the steps of:
aggregating mortgage leads from a plurality of mortgage lead suppliers;
storing mortgage lead order criteria information and mortgage lead source selection information for each of a plurality of mortgage lead buyers; and
using the mortgage lead order criteria information and mortgage lead source selection information to allocate and distribute the mortgage leads to the plurality of mortgage lead buyers.

2. The method of claim 1, wherein the mortgage lead buyers comprise mortgage lenders.

3. The method of claim 2, wherein the mortgage lenders comprise financial institutions.

4. The method of claim 1, wherein the mortgage lead buyers comprise mortgage brokers.

5. The method of claim 1, wherein the mortgage lead suppliers comprise direct marketing firms.

6. The method of claim 1 wherein the order criteria information includes a number of leads requested by each particular one of the plurality of mortgage lead buyers.

7. The method of claim 6 wherein the order criteria information further includes loan type and loan amount information provided by each particular one of the plurality of mortgage lead buyers.

8. The method of claim 1 wherein the mortgage lead source supplier selection information includes supplier ID information and a number of leads per supplier.

9. An automated, computerized method for processing mortgage leads, comprising the steps of:
providing an interface;
utilizing the interface to collect and aggregate a plurality of mortgage leads from a plurality of mortgage lead suppliers; and
operating the interface to allocate and distribute the collected and aggregated mortgage leads to a plurality of mortgage lead buyers such that the mortgage leads collected from each mortgage lead supplier are allocated and distributed to different ones of the mortgage lead buyers, and the mortgage leads distributed to each mortgage lead buyer are received from different ones of the mortgage lead sources.

10. The method of claim 9 comprising the further step of coupling the interface to each of the plurality of mortgage lead suppliers and each of the plurality of mortgage lead buyers via the internet.

11. The method of claim 9 comprising the further step of coupling the interface to each of the plurality mortgage lead suppliers via an interactive web site.

12. The method of claim 9 comprising the further step of coupling the interface to each of the plurality mortgage lead buyers via an interactive web site.

13. The method of claim 9 comprising the further step of coupling the interface to each of the plurality mortgage lead suppliers via transmission of an XML file over the internet.

14. The method of claim 9 comprising the further step of coupling the interface to each of the plurality mortgage lead buyers via transmission of an XML file over the internet.

15. The method of claim 9 comprising the further step of coupling the interface to each of the plurality mortgage lead buyers via transmission of email over the internet.

16. An automated, computerized method for processing mortgage leads, comprising the steps of:
pre-selling a fixed number of mortgage leads for distribution over a preselected period of time to each of a plurality of mortgage lead buyers;
collecting and aggregating a plurality of mortgage leads from a plurality of mortgage lead suppliers; and
allocating and distributing the plurality of mortgage leads to the plurality of mortgage lead buyers as a function of the fixed number of mortgage leads and the preselected period of time.

17. A device for processing mortgage leads, comprising:
an interface; and
a database coupled to the interface, the database storing mortgage lead order criteria information and mortgage lead source selection information for each of a plurality of mortgage lead buyers;
the interface being arranged and configured to aggregate mortgage leads from a plurality of mortgage lead suppliers, and to use the mortgage lead order criteria information and mortgage lead source selection information stored in the database to allocate and distribute the aggregated mortgage leads to the plurality of mortgage lead buyers.

18. The device of claim 17, wherein the interface is coupled to the internet for communication with the plurality of mortgage lead suppliers and the plurality of mortgage lead buyers.

19. An automated, computerized method for processing mortgage leads, comprising the steps of:
providing an interface;
utilizing the interface to collect and aggregate a plurality of mortgage leads from a plurality of mortgage lead suppliers;
operating the interface to allocate and distribute the collected and aggregated mortgage leads to a plurality of mortgage lead buyers such that the mortgage leads collected from each mortgage lead supplier are allocated and distributed to different ones of the mortgage lead buyers, and the mortgage leads distributed to each mortgage lead buyer are received from different ones of the mortgage lead sources; and
further operating the interface to maintain anonymity among and between the plurality of mortgage lead suppliers and the plurality of mortgage lead buyers.

20. An automated, computerized method for processing mortgage leads, comprising the steps of:
aggregating mortgage leads from a plurality of mortgage lead suppliers;
distributing the mortgage leads to the plurality of mortgage lead buyers; and
collecting mortgage lead rating information from the plurality of mortgage lead buyers.

21. The method of claim 20, comprising the further step of utilizing the lead rating information to generate ROI information.

22. An automated, computerized method for processing mortgage leads, comprising the steps of:
aggregating mortgage leads from a plurality of mortgage lead suppliers;
distributing the mortgage leads to the plurality of mortgage lead buyers; and
collecting mortgage lead dispute information from the plurality of mortgage lead buyers.

23. An automated, computerized method for processing mortgage leads, comprising the steps of:
aggregating mortgage leads from a plurality of mortgage lead suppliers;
storing mortgage lead source selection information for each of a plurality of mortgage lead buyers; and
using the mortgage lead source selection information to allocate and distribute the mortgage leads to the plurality of mortgage lead buyers.

24. The method of claim 23 wherein the mortgage lead source selection information is arranged to distribute the mortgage leads such that the mortgage leads distributed to each mortgage lead buyer are received from different ones of the mortgage lead suppliers.

25. The method of claim 23 wherein the mortgage lead source selection information for each of the plurality of mortgage lead buyers is selected by the corresponding mortgage lead buyer.

26. An automated, computerized method for processing mortgage leads, comprising the steps of:
collecting mortgage lead order criteria information from each of a plurality of mortgage lead buyers;
aggregating mortgage leads from a plurality of mortgage lead suppliers; and
using the mortgage lead order criteria information to allocate and distribute the mortgage leads to the plurality of mortgage lead buyers.

27. The method of claim 26 comprising the further steps of prioritizing each of the plurality of mortgage lead buyers as a function of the mortgage lead order criteria information, and using the mortgage lead order criteria information to allocate and distribute the mortgage leads in order of the prioritization.
